(19) United States
(12) Patent Application Publication
(10) Pub. No.: US 2005/0130011 A1
(43) Pub. Date: Jun. 16, 2005

(54) Fuel cell system

(76) Inventors: Stephen F. Burgess, Cromwell, CT (US); Douglas R. Ausdemore, Manchester, CT (US)

Correspondence Address: Cynthia S. Murphy;RENNER, OTTO, BOISSELLE & SKLAR, LLP, Nineteenth Floor, 1621 Euclid Avenue, Cleveland, OH, 44115, US

(21) Appl. No.: 10/978,847

(22) Filed: Nov. 1, 2004

Related U.S. Application Data
(60) Provisional application No. 60/517,225, filed on Oct. 31, 2003.

(51) Int. Cl. H01M 8/04; H01M 8/06

(52) U.S. Cl. 429/34; 429/19

(57) ABSTRACT

A fuel cell system (12) wherein a fluid-supplying device (10) supplies a cathode gas (e.g., an oxygen-containing gas) and an anode gas (e.g., a hydrogen-containing gas) to a fuel cell (14). The fluid-supplying device (12) comprises a cathode-side compressor (30c), an anode-side compressor (30a), and a motor (32). The motor (32) is driveably coupled to both the rotor (62c) of the cathode-side compressor (30c) and the rotor (62a) of the anode-side compressor (30a).

### RELATED APPLICATION

This application claims priority under 35 U.S.C. §119(e) to U.S. Provisional Patent Application No. 60/517,225 filed on Oct. 31, 2003 and entitled “Dual Compressor System.” The entire disclosure of this provisional application is hereby incorporated by reference.

### FIELD OF THE INVENTION

This invention relates generally to a fuel cell system and, more particularly, to a system wherein an oxygen-containing gas is fed to the cathode chamber of a fuel cell and a hydrogen-containing gas is fed to its anode chamber.

### BACKGROUND OF THE INVENTION

A fuel cell comprises a cathode chamber, an anode chamber, and an electrolyte (or ion-conducting) separator positioned therebetween. During operation of the fuel cell, an oxygen-containing gas passes through the cathode chamber, a hydrogen-containing gas passes through the anode chamber, and the hydrogen reacts with the oxygen to generate electricity. The oxygen-containing gas can be atmospheric air which is fed through the cathode chamber via an air compressor. The hydrogen-containing gas can be produced by feeding, via another compressor, a gas through a reformer and then feeding the reformed gas through the anode chamber. Also, exhaust from the anode chamber can be recirculated, via a fluid-handler, back through the anode chamber.

Accordingly, a fuel cell system will include compressors and other fluid-handlers which supply gases to the cathode/anode chambers. In such a system, it is important that lubricating liquids not be introduced into the cathode chamber and/or the anode chamber, as such lubricants can poison the electrolyte or otherwise harm effective electricity-generating reactions. Thus, a fuel cell system will include compressors and/or other fluid-handlers wherein the fluid-contacting components do not use lubrication.

### SUMMARY OF THE INVENTION

The present invention provides a fuel cell system wherein a single motor is used to supply both cathode gas to the fuel cell's cathode chamber and anode gas to its anode chamber. This single-motor supply reduces the system cost, complexity, and power consumption. Moreover, this dual cathode/anode supply can be accomplished, at a high efficiency, without liquid lubrication of gas-contacting components.

More particularly, the present invention provides a fuel cell system comprising a fuel cell and a fluid-supplying device. The fuel-supplying device includes a first fluid-handler (e.g., a first compressor), a second fluid-handler (e.g., a second compressor), and a motor. The first fluid-handler supplies a cathode gas to the cathode chamber of the fuel cell and the second fluid-handler supplies an anode gas to its anode chamber. The motor can be an electric motor and, in any event, drives both the first compressor's rotor and the second compressor's rotor.

The fluid-handlers can each comprise a stator surface concentrically positioned around a stator axis, and the rotor can be positioned within the space defined by the stator surface for eccentric rotation therein about a rotor axis. The fluid handlers can each also comprise a vane which, upon rotation of the rotor, is rotated about the stator axis. During this rotation, the tip of the vane follows a close, but non-contacting, path around the stator surface. This travel path of the vane can accomplish effective interface sealing without the use of lubricants.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIG. 1 is a schematic drawing of a fuel cell system incorporating a fluid-supplying device according to the present invention.

FIG. 2 is a schematic drawing of another fuel cell system incorporating a fluid-supplying device according to the present invention.

FIGS. 3, 4 and 5, are front, side, and top views, respectively, of the fluid-supplying device.

FIG. 6 is a sectional view as seen along line 6-6 in FIG. 5.

### DETAILED DESCRIPTION

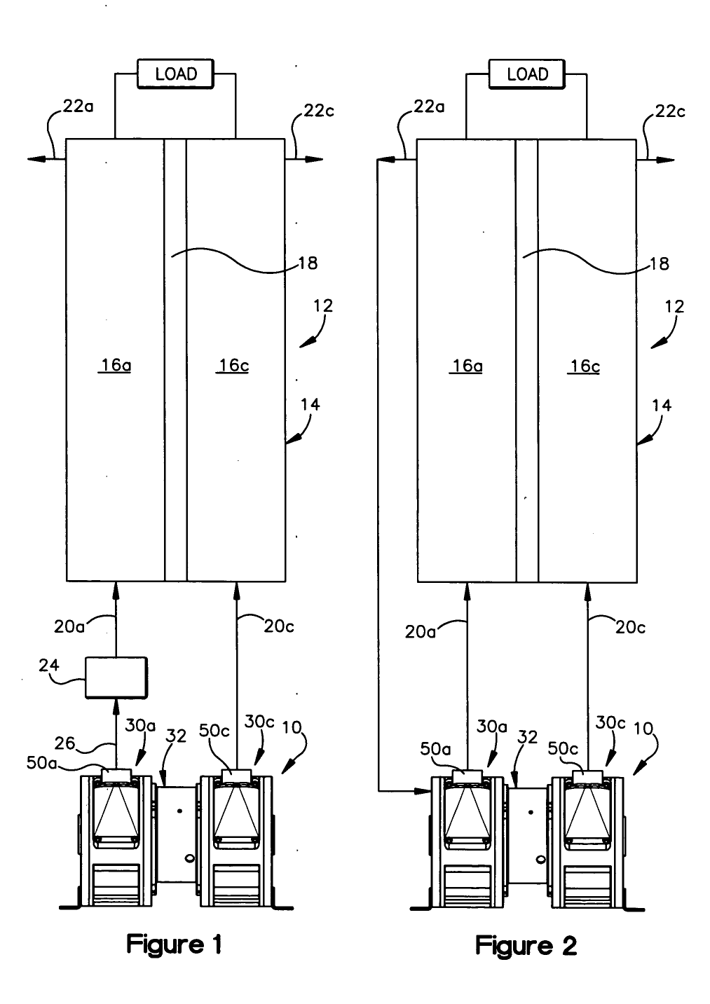

Referring now to the drawings, and initially to FIGS. 1 and 2, a fluid-supplying device 10 according to the present invention is shown in a fuel cell system 12. The fuel cell system 12 comprises a fuel cell 14 having a cathode chamber 16c, an anode chamber 16a, and an electrolyte (or ion-conducting) separator 18 positioned therebetween. During operation of the fuel cell 14, a cathode gas (e.g., an oxygen-containing gas) passes through the cathode chamber 16c, an anode gas (e.g., a hydrogen-containing gas) passes through the anode chamber 16a, and the gasses react to generate electricity.

The illustrated fuel cell 14 includes an inlet 20c into and an outlet 22c out of the cathode chamber 16c, and an inlet 20a into and an outlet 22a out of the anode chamber 16a. As shown in FIG. 1, the fuel cell system 12 can also comprise a reformer 24 which is positioned upstream of the fuel cell 14 and which includes an inlet 26 through which a non-reformed fluid is provided. The non-reformed fluid is reformed into the hydrogen-containing gas which is then supplied to the anode outlet 22a.

It should be noted that the fuel cell system 12 is shown only schematically in the drawings and can include other components upstream and downstream of the fuel cell 14. For example, the system 12 can include a carbon monoxide eliminator downstream of the reformer 24, and/or vaporizer upstream of the reformer 24. A mixing tank, a regulator, a pump, and/or valving can be provided downstream of the fuel tank and upstream of the reformer 24. A condenser, a radiator, an ion-exchanger, drains, valving, or other components can be provided for the handling of the exhaust from the outlets 22. As for the fuel cell 14, the simplicity of the illustration is for ease in explanation only, as it could comprise a plurality of cathode/anode chambers 16 and a plurality of separators 18 stacked or otherwise assembled to provide the desired generation of electricity.

The fluid-supplying device 10 supplies, directly and/or indirectly, the fuel cell 14 with oxygen and hydrogen for the generation of electricity. For example, in FIG. 1, the fluid-supplying device 10 feeds atmospheric air (or another oxygen-containing gas) through the cathode chamber 16c and also feeds non-reformed fuel through the reformer 24. In FIG. 2, the fluid-supplying device 10 feeds atmospheric air (or another oxygen-containing gas) through the cathode chamber 16c and recirculates exhaust from the anode outlet 22a back to the anode inlet 20a. As is explained in more detail below, the device 10 accomplishes this dual supply with a single motor (namely motor 32, introduced below) and with effective non-lubrication interface sealing between fluid-contacting components.

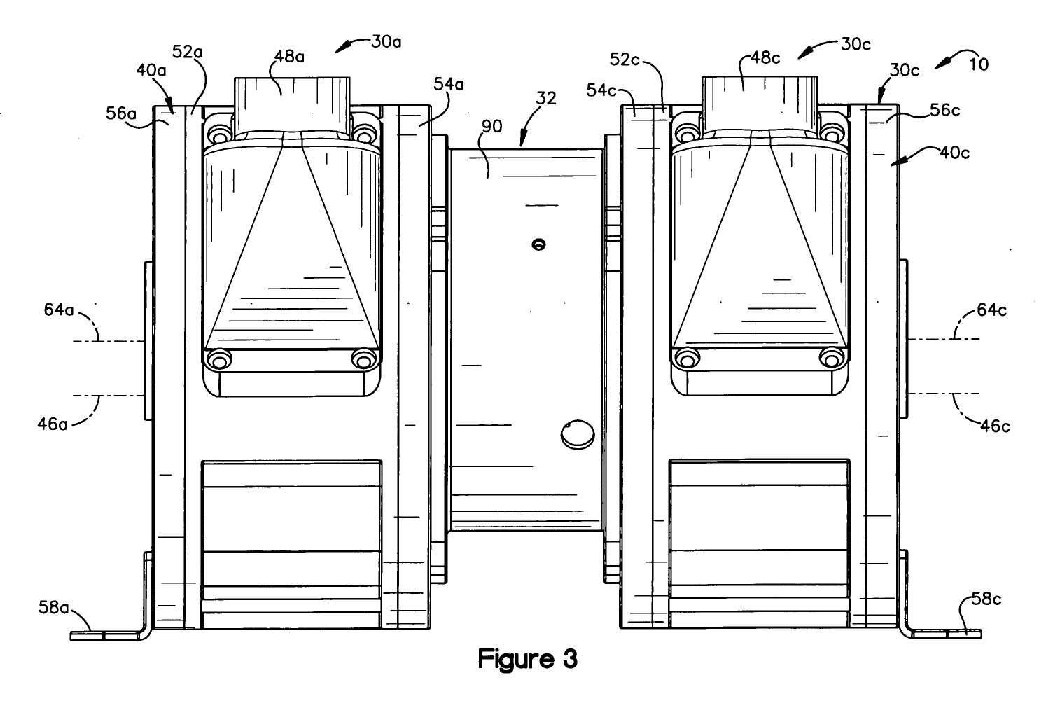

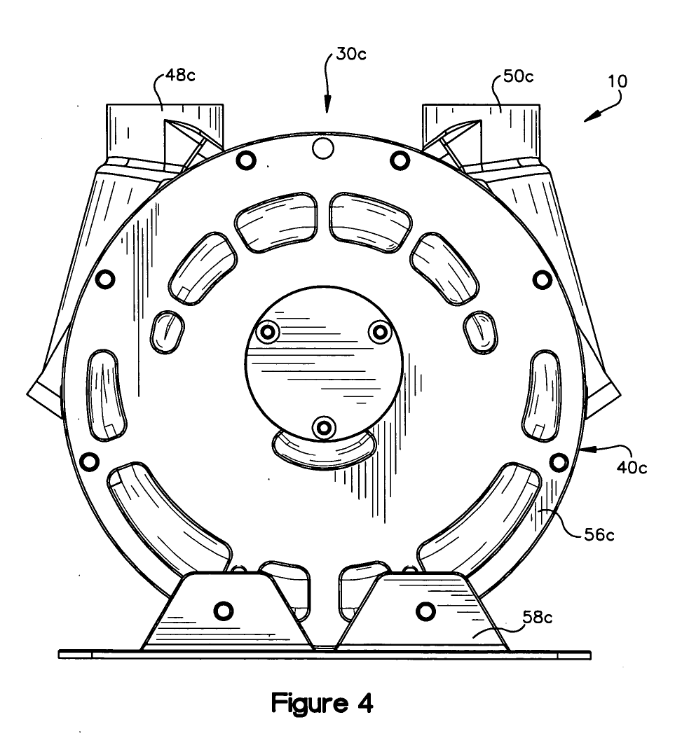

Referring now to FIGS. 3-6, the fluid-supplying device 10 is shown in detail. The fluid-supplying device 10 comprises a cathode-side compressor 30c, an anode-side compressor 30a, and a motor 32 positioned therebetween. (FIGS. 3, 5 and 6.) It may be noted that the compressors 30 each resemble the fluid-handlers set forth in U.S. Pat. Nos. 5,087,183; 5,160,252; 5,374,172, 6,503,071; and/or 6,623,261, and the entire disclosure of these patents is hereby incorporated by reference.

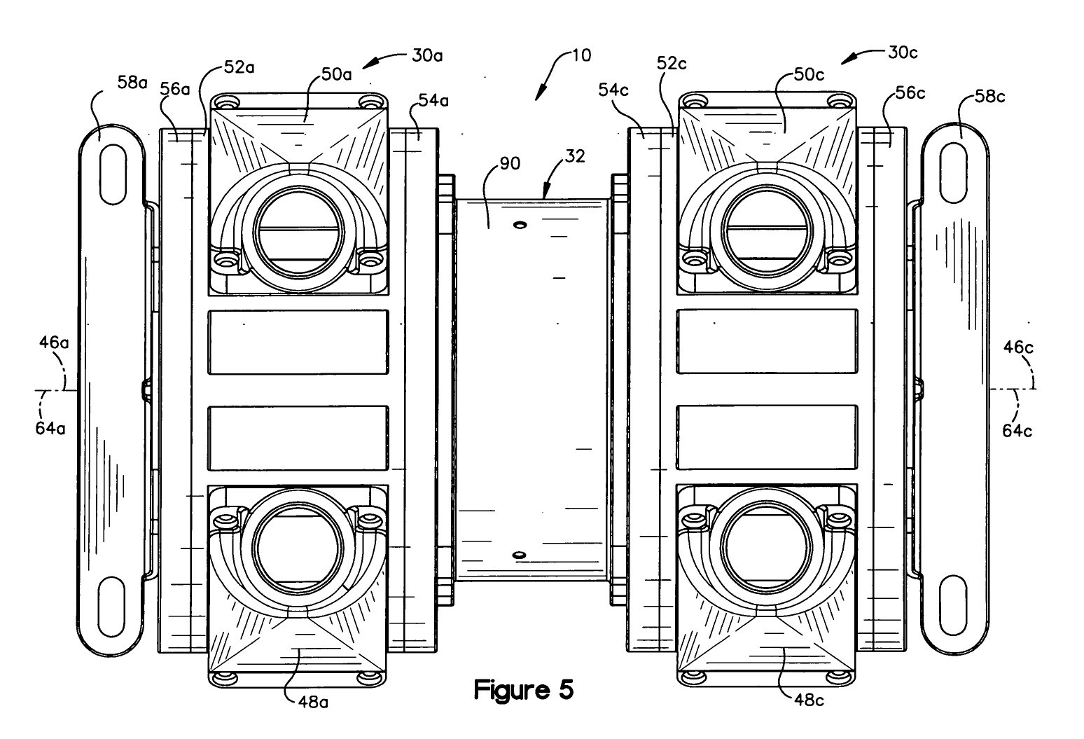

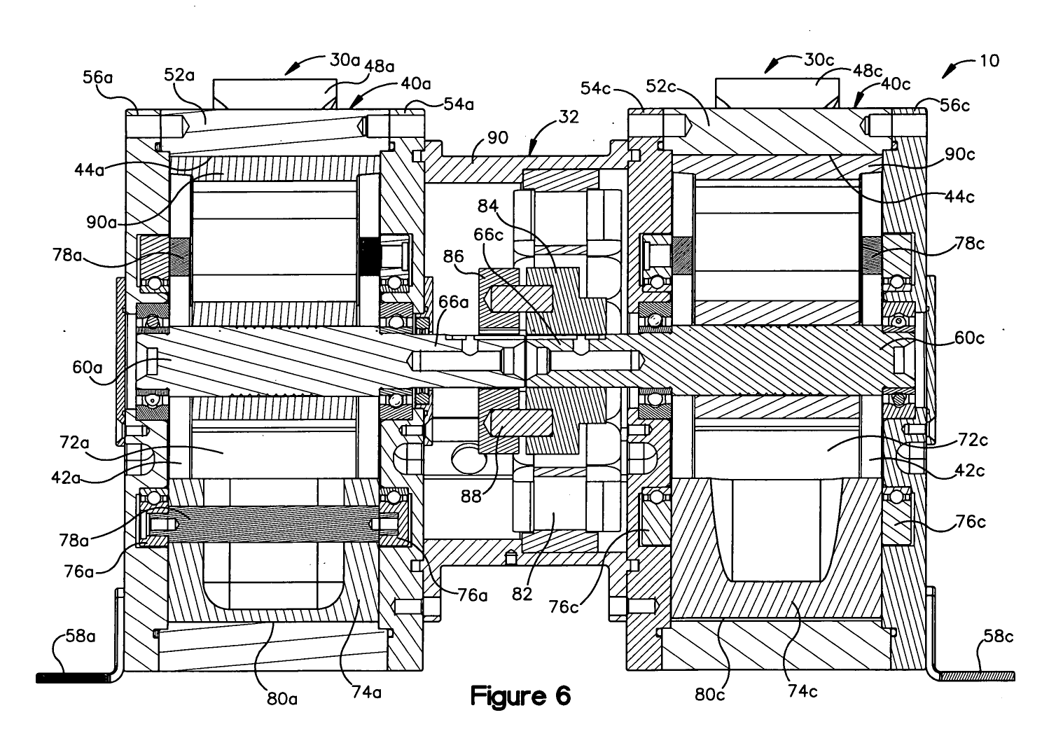

The cathode-side compressor 30c comprises a stator housing 40c forming a cylindrical space 42c defined by a continuous inner surface 44c which curves concentrically around an axis 46c. (FIG. 6.) An inlet fitting 48c and an outlet fitting 50c are mounted on the housing 40c and communicate with the space 42c. (FIGS. 3 and 5.) In the illustrated embodiment, the stator housing 40c comprises a cylindrical side wall 52c, an inner (i.e., motor adjacent) end wall 54c, and an outer (i.e., motor remote) end wall 56c. (FIGS. 3, 5 and 6.) A bracket 58c can be provided to mount the stator housing 40c to the floor or another suitable platform. (FIGS. 3-6.)

The compressor 30c also comprises a rotor shaft 60c and a rotor 62c. (FIG. 6.) The rotor shaft 60c is rotatably mounted to the stator housing 40c and, during operation of the device 10, is driven by the motor 32 to rotate about an axis 64c. The rotor axis 64c is parallel with, but spaced a predetermined distance from, the stator axis 46c so that the rotor 62c can be eccentrically positioned within the stator space 42c. (FIG. 3, 4 and 5.) The rotor shaft 60c includes a motor-coupling portion 66c which extends through the end wall 54c and into the motor 32. (FIG. 6.) The cylindrically-shaped rotor 62c is mounted to the shaft 60c for rotation therewith and includes a vane-receiving slot 72c. (FIG. 6.)

The compressor 30c further comprises a single vane 74c having an axial dimension corresponding to that of the rotor 62c, cross-sectional dimensions corresponding to the rotor slot 72c, and a radial dimension corresponding to the stator surface 44c. (FIG. 6.) Annular bearing guides 76c, concentric with the stator axis 46c, are mounted on the housing end walls 54c/56c, and their rotating races are joined by connecting rods 78c. (FIG. 6.) The vane 74c is slidably received within the rotor slot 72c and connected to the guides 76c via one of the connecting rods 78c. (FIG. 6.) In this manner, rotation of the rotor 62c about the axis 64c results in rotation of the vane 74c about the stator axis 46c and the vane's tip 80c follows a non-contacting and interface-sealing path around the stator surface 44c.

The anode-side compressor 30a can comprise the same components as the cathode-side compressor 30c and like reference numerals (with an “a” rather than a “c” suffix) are used to designate like parts. The rotor axis 64c of the cathode-side compressor 30c is coextensive with the rotor axis 65a of the anode-side compressor 30a and, preferably the stator axes 46c and 46a are also coextensive. (FIGS. 3 and 5.) In the illustrated embodiment, the axial length of the space 42c defined by the stator surface 44c of the cathode-side compressor 30c is substantially equal to the axial length of the space 42a defined by the stator surface 44a of the second compressor 30a. (FIGS. 3, 5 and 6.) However, the axial dimension of the stator spaces 42 can be the same, or varied, as the relationship therebetween will at least partially dictate the correlation between cathode/anode flow conditions.

The illustrated motor 32 is an electric motor that comprises a stator 82, a rotor 84, a coupling ring 86 attached to the rotor 84 via connectors 88, and a casing 90 surrounding these components. (FIG. 6.) The compressors' motor-coupling rotor portions 66c/66a extend into the casing 90 with their ends abutting therewithin. (FIG. 6.) The casing 90 acts as a bridge which connects the stator housings 40c/40a together and joins the fluid handlers 30c/30a and the motor 32 into a single unit. Within the casing 90, the cathode-side shaft portion 66c extends through, is connected to, and rotates with the rotor 84; and the anode-side shaft portion 66a extends through, is connected to, and rotates with the coupling ring 86. (FIG. 6.) The connectors 88 can be cylindrical elements received within aligned bores in the rotor 84 and the ring 68, and can be made of firm, but resilient material (e.g., rubber) to allow a small degree of give between the respective shafts 60c/60a. Suitable lubricant may be provided within the motor casing 90 and suitable sealing may be provided to prevent escape of any lubricant into the stator housings 40c/40a of the compressors 30c/30a.

Although the invention has been shown and described with respect to certain preferred embodiments, it is obvious that equivalent and obvious alterations and modifications will occur to others skilled in the art upon the reading and understanding of this specification. For example, the rotor shafts 60c/60a could be replaced with a rotor single shaft and/or the motor 32 could be a non-electric mechanism. Also, the fluid-supplying device 10 need not be used in a fuel cell system 12 and/or with a fuel cell 14, as it may find application in other compressor situations where lubricating liquids would be harmful and even in situations where lubrication can be tolerated. Moreover, the fluid-handlers 30c and 30a can function as both expanders and compressors, depending upon which the fixture 48/50 is used as the inlet/outlet. In fact, one component 30c/30a could function as a compressor while the other component 30a/30c functions as an expander.

One may now appreciate that the present invention provides a fluid-supplying device 10 that can be used to supply an oxygen-containing gas to a cathode chamber 16c and a hydrogen-containing gas to the anode chamber 16a of a fuel cell 14. The device 10 accomplishes this dual supply with a single motor 32 and with effective non-lubrication sealing within compressor components 30c and 30a.

1. A fuel cell system comprising a fuel cell and a fluid-supplying device;
the fuel cell comprising a cathode chamber, an anode chamber, and an electrolyte positioned therebetween;
the fluid-supplying device comprising a first fluid-handler, a second fluid-handler, and a motor driveably coupled to both a rotor of the first fluid-handler and a rotor of the second fluid-handler; and
wherein the first fluid-handler supplies a cathode gas to the cathode chamber and the second fluid-handler supplies an anode gas to the anode chamber.

2. A fuel cell system as set forth in claim 1, wherein at least one of the first fluid handler and the second fluid-handler is a compressor.

3. A fuel cell system as set forth in claim 2, wherein both of the first fluid handler and the second fluid-handler are compressors.

4. A fuel cell system as set forth in claim 1, wherein the fluid-handler supplies an oxygen-containing gas to the cathode chamber and the second fluid-handler supplies a hydrogen-containing gas to the anode chamber.

5. A fuel cell system as set forth in claim 4, wherein the first fluid-handler supplies atmospheric air to the cathode chamber.

6. A fuel cell system as set forth in claim 4, further comprising a reformer and wherein the second fluid-handler supplies a non-reformed fuel to the reformer.

7. A fuel cell system as set forth in claim 6, wherein the first fluid-handler supplies atmospheric air to the cathode chamber.

8. A fuel cell system as set forth in claim 4, wherein the second fluid-handler recirculates exhaust from an outlet of the anode chamber back through an inlet to the anode chamber.

9. A fuel cell system as set forth in claim 1, wherein the rotor of the first fluid-handler rotates about a rotor axis, wherein the rotor of the second-fluid handler rotates about a rotor axis, and where these rotor axes are coextensive.

10. A fuel cell system as set forth in claim 1, wherein the motor is an electric motor.

11. A fuel cell system as set forth in claim 1, wherein the fluid-handlers each include a rotor shaft to which the respective rotor is attached, and wherein the motor comprises a rotor directly attached to one of these rotor shafts.

12. A fuel cell system as set forth in claim 11, wherein the motor comprises a coupling element attached to the motor's rotor and wherein the coupling element is attached to the other of these rotor shafts.

13. A fuel cell system as set forth in claim 12, wherein the coupling element is a coupling ring and wherein the respective rotor shaft extends through a central opening in the coupling ring.

14. A fuel cell system as set forth in claim 1, wherein the fluid-handlers each include a rotor shaft to which the respective rotor is attached, wherein the motor comprises a rotor and a coupling element attached thereto, and wherein this coupling element is attached to one of the fluid-handlers' rotor shafts.

15. A fuel cell system as set forth in claim 1, wherein the motor comprises a stator, a rotor, and a casing which surrounds the rotor and the stator, wherein the fluid-handlers each include a rotor shaft to which the respective rotor is attached, and wherein the rotor shaft of the first fluid-handler and the rotor shaft of the second fluid-handler each comprise a coupling portion which extend into the casing.

16. A fuel cell system as set forth in claim 15, wherein the ends of the coupling portions of the fluid-handlers' rotor shafts abut within the casing.

17. A fuel cell as set forth in claim 1, wherein the axial length of the space defined by the stator surface of the first fluid-handler is substantially equal to the axial length of the space defined by the stator surface of the second fluid-handler.

18. A fuel cell system as set forth in claim 1, wherein each fluid-handler comprises a stator surface concentrically positioned around a stator axis, and wherein the stator axis is parallel to but offset from the rotor axis whereby the rotor is eccentrically rotatable within a space defined by the stator surface.

19. A fuel cell system as set forth in claim 18, wherein the rotor axis of the first fluid-handler is coextensive with the rotor axis of the second fluid-handler, and the stator axis of the first fluid-handler is coextensive with the stator axis of the second fluid-handler.

20. A fuel cell system as set forth in claim 18, wherein each fluid-handler further comprises a vane which is rotated about the respective stator axis upon rotation of the respective rotor about the rotor axis and which includes a tip that follows a non-contacting and interface-sealing path around the stator surface during this rotation.

21. A fluid-supplying device comprising a first fluid-handler, a second fluid-handler, and a motor;
wherein the first fluid-handler comprises a stator surface concentrically positioned around a stator axis, a rotor positioned within a space defined by the stator surface and eccentrically rotatable within the space about a rotor axis parallel to the stator axis, and a vane which is rotated about the stator axis upon rotation of the rotor about the rotor axis and which includes a tip that follows a non-contacting and interface-sealing path around the stator surface during this rotation;
wherein the second fluid-handler comprises a stator surface concentrically positioned around a stator axis, a rotor positioned within a spaced defined by the stator surface and eccentrically rotatable within the space about a rotor axis parallel to the stator axis, and a vane which is rotated about the stator axis upon rotation of the rotor about the rotor axis and which includes a tip that follows a non-contacting and high-sealing path around the stator surface during this rotation; and
wherein the motor is driveably coupled to both the rotor of the first fluid-handler and the rotor of the second fluid-handler.

22. A fluid-supplying device as set forth in claim 21, wherein the rotor axis of the first fluid-handler is coextensive with the rotor axis of the second fluid-handler.

23. A fluid-supplying device as set forth in claim 21, wherein the stator axis of the first fluid-handler is coextensive with the stator axis of the second fluid-handler.

24. A fluid-supplying device as set forth in claim 1, wherein the motor is an electric motor.

25. A fluid-supplying device as set forth in claim 21, wherein the fluid-handlers each include a rotor shaft to which the respective rotor is attached, and wherein the motor comprises a rotor directly attached to one of these rotor shafts.

26. A fluid-supplying device as set forth in claim 25, wherein the motor comprises a coupling element attached to the motor's rotor and wherein the coupling element is attached to the other of these rotor shafts.

27. A fluid-supplying device as set forth in claim 26, wherein the coupling element is a coupling ring and wherein the respective rotor shaft extends through a central opening in the coupling ring.

28. A fluid-supplying device as set forth in claim 21, wherein the fluid-handlers each include a rotor shaft to which the respective rotor is attached, wherein the motor comprises a rotor and a coupling element attached thereto, and wherein this coupling element is attached to one of the fluid-handlers' rotor shafts.

29. A fluid-supplying device as set forth in claim 21, wherein the motor comprises a stator, a rotor, and a casing which surrounds the rotor and the stator, wherein the fluid-handlers each include a rotor shaft to which the respective rotor is attached, and wherein the rotor shaft of the first fluid-handler and the rotor shaft of the second fluid-handler each comprise a coupling portion which extend into the casing.

30. A fluid-supplying device as set forth in claim 29, wherein the ends of the coupling portions of the fluid-handlers' rotor shafts abut within the casing.

31. A fluid-supplying device as set forth in claim 21, wherein the axial length of the space defined by the stator surface of the first fluid-handler is substantially equal to the axial length of the space defined by the stator surface of the second fluid-handler.

32. A fluid-supplying device as set forth in claim 21, wherein the vane of the first fluid-handler and the vane of the second fluid-handler are the single vanes for each of the fluid-handlers.

33. A fluid-supplying device as set forth in claim 21, wherein the non-contacting and high-sealing path around the stator surface is a non-lubricated path.

34. A fluid-supplying device as set forth in claim 21, wherein the first fluid-handler and the second fluid-handler each comprise a housing which includes the respective stator surface and a rotor shaft to which the respective rotor is connected, and wherein the respective rotor shaft is rotatably mounted to the housing.

35. A fluid-supplying device as set forth in claim 21, wherein the first fluid-handler and the second fluid-handler each comprise a first guide and a second guide mounted on opposite end walls of the respective stator housing and wherein the respective vane is movably connected to the guides.

36. A fluid-supplying device as set forth in claim 35, wherein the guides are annular bearing guides concentric with the stator axis.

37. A fluid-supplying device as set forth in claim 21, wherein at least one of the fluid-handlers is a compressor.

38. A fluid-supplying device as set forth in claim 37, wherein both of the fluid-handlers are compressors.
